(19) United States
(12) Patent Application Publication
(10) Pub. No.: US 2019/0027068 A1
(43) Pub. Date: Jan. 24, 2019

(54) SYSTEM AND METHODS FOR COMMUNICATING THE CONTENT OF CANNABIS PRODUCTS

(71) Applicant: Vireo Health LLC, Minneapolis, MN (US)

(72) Inventor: Kyle Kingsley, Minneapolis, MN (US)

(73) Assignee: Vireo Health LLC, Minneapolis, MN (US)

(21) Appl. No.: 15/436,487

(22) Filed: Feb. 17, 2017

Related U.S. Application Data
(60) Provisional application No. 62/296,428, filed on Feb. 17, 2016.

(51) Int. Cl. G09F 3/02

(52) U.S. Cl. CPC G09F 3/02; G09F 2003/0273

(57) ABSTRACT

The present invention relates to systems and methods for rapidly and accurately communicating the ratio of various cannabinoids contained in a cannabis containing product. Particularly the methods involve the steps of determining the ratio of THC to CBD in the product, assigning a color to be associated with that ratio and labeling the cannabis containing product with a label that prominently features that color.

### STATEMENT REGARDING FEDERALLY SPONSORED RESEARCH

N/A

### FIELD OF THE INVENTION

The present invention relates to the use of product labels. In particular to methods of labeling cannabis containing products to rapidly and accurately communicate the ratio of THC to CBD in the products.

### BACKGROUND OF THE INVENTION

With legal cannabis now available in many states, the importance of communicating quickly and easily the contents and characteristics of cannabis products has risen. Cannabis varies in its effects depending on several factors including but not limited to the constituent makeup of the cannabis product and its method of delivery. Of particular importance to consumers of cannabis products is the ratio of THC to CBD, the presence or absence of lesser cannabinoids, the presence or absence of terpenes, the form (formulation) of the cannabis product and the like.

### SUMMARY OF THE INVENTION

Therefore, in one embodiment the invention is a label for a cannabis product comprising a colored section wherein the color of the colored section is associated with a ratio, or range of ratios indicating the ratio of THC to CBD.

In another embodiment the invention is a method for communicating the contents of a cannabis product comprising the steps of determining the ratio of THC to CBD in the cannabis product, assigning that ratio a color so that the color is associated with that ratio, and labeling the cannabis product with a product label which prominently features the color associated with the product's THC to CBD ratio.

In another embodiment the invention is a legend to be associated with a cannabis product, by placing said legend on the label of the cannabis product, or otherwise, wherein the legend comprises a plurality of segments, and each segment communicates an characteristic of the cannabis product associated with the legend.

In another embodiment the invention is a method of titrating the dose of a cannabinoid containing product comprising the steps of assessing a patient's symptoms, selecting an initial cannabis based medication from the spectrum, allowing the patient to take the cannabis based product, reassessing the patient's symptoms and assessing any side effects, and either selecting a different cannabis based medication from the spectrum or maintaining the patient on the previously selected cannabis based medicine from the spectrum.

### BRIEF DESCRIPTION OF THE DRAWINGS

FIG. 1 shows a flow chart of the color spectrum to be associated with various THC to CBD ratios.

FIG. 2 shows several examples of exemplary product labels utilizing the spectrum labeling approach.

FIG. 3 shows several examples of exemplary packaging labeled with labels utilizing the spectrum labeling approach.

FIG. 4 is a table showing a range of ratios of THC to CBD that may be associated with various colors.

FIG. 5 shows a legend which can be used to rapidly communicate various characteristics of a cannabis product

### DETAILED DESCRIPTION

These and other systems, methods, objects, features, and advantages of the present disclosure will be apparent to those skilled in the art from the following detailed description of the embodiments and drawings.

All documents mentioned herein are hereby incorporated in their entirety by reference. References to items in the singular should be understood to include items in the plural, and vise versa, unless explicitly stated otherwise or clear from the text. Grammatical conjunctions are intended to express any and all disjunctive and conjunctive combinations of conjoined clauses, sentences, words, and the like, unless otherwise stated or clear from context

In an embodiment the invention is a system and method for labeling cannabis products such that the label quickly and accurately conveys important information about the product to interested parties such as consumers, medical professionals, dispensary personnel and the like. In an embodiment the information conveyed is the ratio of THC to CBD, although the ratios of other cannabinoids may be communicated as well. In an embodiment, decreasing ratios of THC to CBD are associated with different colors along the visible light spectrum, namely: red, orange, yellow, green, blue, indigo and violet. Where red has the highest THC to CBD ratio and violet has the lowest ratio of THC to CBD (but the highest CBD to THC ratio). In some embodiments all of the colors on the spectrum are used. In other embodiments a selection of colors along the spectrum are used, for example red, yellow, green, blue and indigo. The use of this invention allows interested parties to look briefly at a product label and instantly understand the THC to CBD ratio of the labeled product and inform their choice on which product to select and/or recommend.

An important first step to implementing the systems and methods described herein is the quantitation of the contents of the cannabis products. This may be done using any methods known to those having skill in the art such as, HPLC, spectroscopy, ELISA and the like. Once the product has been analyzed, and in particular, once the ratio of THC to CBD as well as their absolute quantities have been determined, a color can be assigned to each ratio and/or range of ratios. In some cases, the cannabis products to be labeled will be adjusted so that the ratios contained therein will conform to desire d ratios.

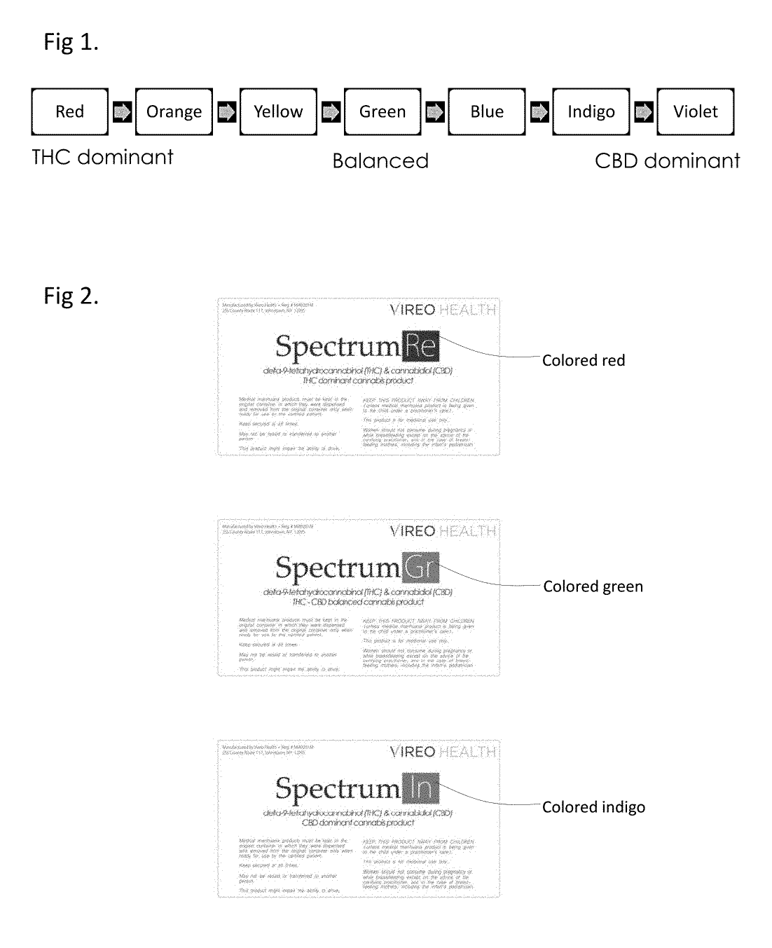

FIG. 1 shows a flow chart of the visible light spectrum that defines visible colors. While intermediate colors are present, these 7 colors are well known to most people by the acronym “ROY G BIV”. Because most people are familiar with the concept of the color spectrum it makes the association between these colors and THC to CBD ratios more readily grasped and internalized, facilitating the selection of an appropriate product.

FIG. 2 shows several examples of cannabis product labels incorporating this labeling paradigm. As shown in the figures it is not required that the labels merely state the name of the color, rather the labels can incorporate other branding elements and techniques such as a unique product name, in this case “Spectrum,” while still being associated with the color indicating the contained THC to CBD ratio.

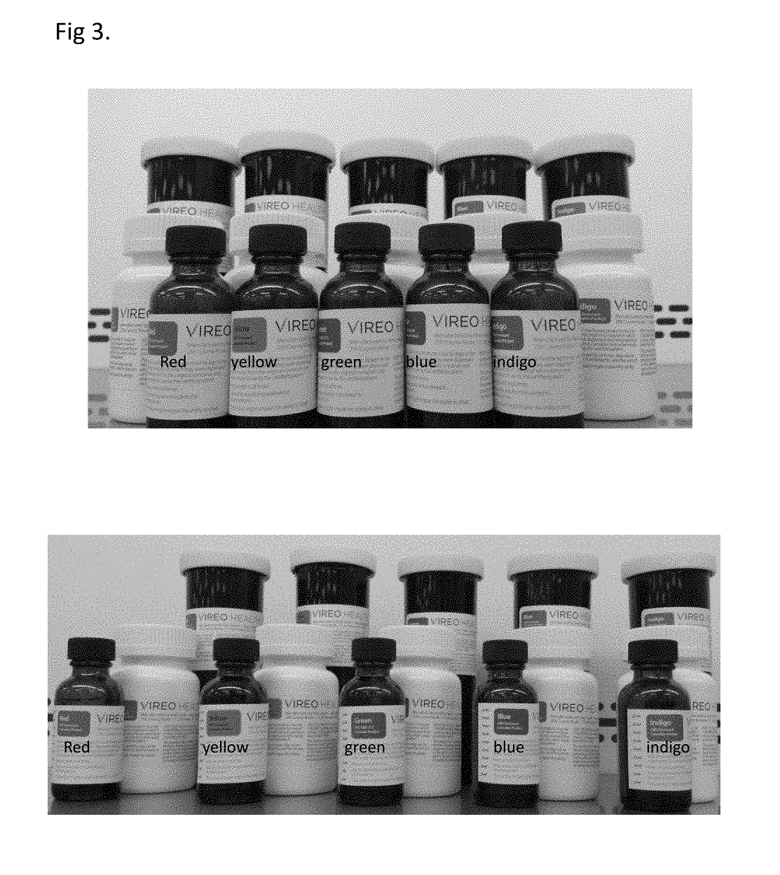

FIG. 3 shows several examples of packaging that have incorporated the labeling method of the present invention. As is illustrated by this example, it is very easy to recognize the colored labels even from a substantial distance, providing a unique and useful tool to enable manufacturers of cannabis products to communicate information about their products.

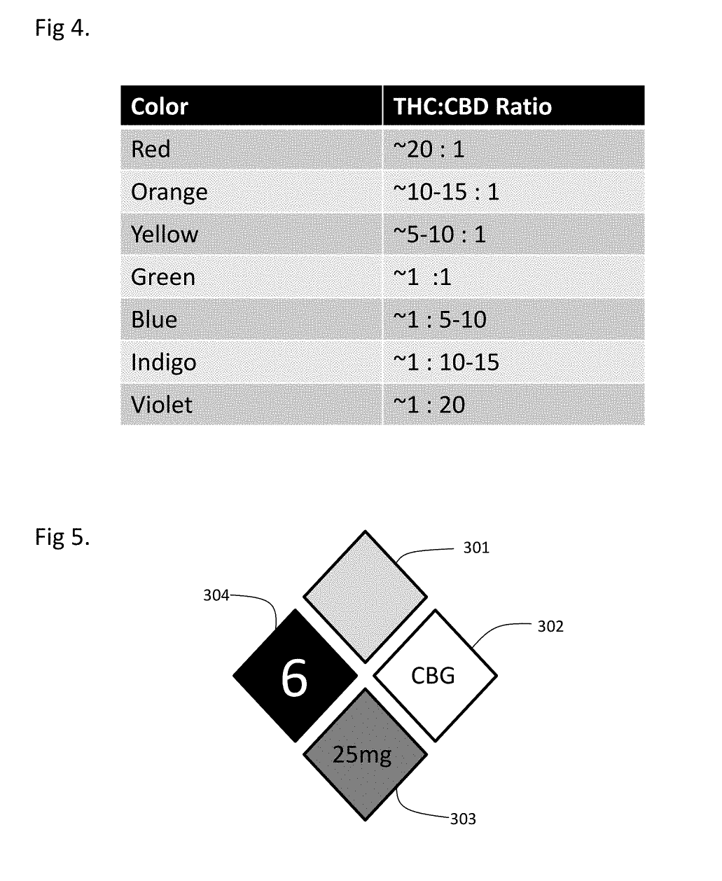

FIG. 4 provides a table of the ratios of THC to CBD and the colors with which they are associated. It should be clear to those having skill in the art that these ratios are examples and other ratios may be used as the formulations of the products vary.

FIG. 5 shows an example of a product legend that may be present on some embodiments of the labels of the present invention. Panel 301 is the “spectrum” panel which shows the color associated with the THC to CBD of the product. For example red, orange, yellow, green, blue, indigo and violet. Panel 302 shows the minor cannabinoid panel which indicates which of the minor cannabinoids are present in the formulation. Panel 303 shows the unit dosage of the packaged cannabis product (Xmg per capsule, Xmg/ML, etc). Panel 304 is the terpene panel. In the pictured embodiment, the terpene panel shows a number from 1-10 indicating the level of terpenes in the product, where 1 indicates an almost total lack of terpenes, 10 indicates a level of terpenes equivalent to 5-10 fold higher than are present in raw flower cannabis and 5 represents approximately the level of terpenes that occur naturally in raw cannabis. Terpenes are volatile compounds that are associated with the unique scent and flavor profiles of cannabis products. It is also likely that terpenes exert physiological effects. Therefore the presence of terpenes will be desirable in some circumstances and undesirable in others. The terpene panel enables interested parties to rapidly assess the level of terpenes present in a product and use that information to inform their decisions. While diamonds are shown as representative legend panels, other shapes and arrangements may be substituted in other embodiments. Further other characteristics of the cannabis products be substituted for those specifically mentioned herein.

In another embodiment the invention is a method for selecting and or adjusting the dose of a cannabis containing product being provided to a patient or customer. In particular, adjusting the ratio of THC to CBD of a cannabinoid containing product being provided. The method comprising the steps of assessing a patient's symptoms, selecting an initial cannabis based medication from a spectrum of products wherein the ratio of THC to CBD various along the spectrum, and each ratio of THC to CBD is assigned a color in the visible light spectrum, allowing the patient to take the cannabis based product, reassessing the patient's symptoms and assessing any side effects, and either selecting a different cannabis based medication from the spectrum or maintaining the patient on the previously selected cannabis based medicine from the spectrum. With respect to assessing a patient's symptoms and selecting an appropriate spectrum product, medical practitioners and others having skill in the art will be familiar with the effects of THC and CBD respectively and will be able to make an initial recommendation of the ratio of THC to CBD to address the patient's issues. After the initial recommendation, the patient will be allowed to take the recommended cannabis product for a time interval. Time intervals will vary depending on the patient's needs, but it is estimated that a period between 1 week and 4 weeks is sufficient to make the necessary determinations. The patient will track his or her symptoms, note improvements, side effects and/or other occurrences associated with the cannabis based product. This monitoring may be done informally, such as for example by having the caregiver ask questions of the patient during the interval. Alternatively it can be done in a more formal fashion such as by having the patient routinely fill out questionnaires during the interval that may be provided electronically. The care giver then assesses the patient's responses to the cannabis based product and makes a determination as to whether the cannabis based product should be changed or kept the same. If the caregiver makes the determination that the product should be changed, the caregiver can move up or down on the spectrum to adjust the ratio of THC to CBD given to patients in a manner that is in accordance to the patient's responses to the cannabis based product. In this way the method and systems described are a useful tool for helping caregivers select the correct cannabis based product for their patients. Although, the use of the spectrum method has been described for use in patients in a medical setting, the spectrum method may also be used in recreational settings in those states where recreational cannabis used is authorized by law. In such cases the terms patient and caregiver may be substituted with the terms ‘client’ or ‘customer’ and ‘cannabis provider’ respectively.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

With respect to the above, it is to be understood that the invention is not limited in its application to the details of construction and to the arrangement of the components listed or the steps set forth in the description or illustrated in the drawings. The various apparatus and methods of the disclosed invention are capable of other embodiments, and of being practiced and carried out in various ways that would be readily known to those skilled in the art, given the present disclosure. Further, the terms and phrases used herein are for descriptive purposes and should not be construed as in any way limiting.

What is claimed is:

1. A method for communicating the contents of a cannabis product comprising:
a. determining the ratio of THC to CBD in the cannabis product;
b. assigning a color to the determined THC to CBD ratio; and
c. labeling the cannabis product with a product label which features the color assigned to the product's THC to CBD ratio.

2. The method of claim 1 wherein the cannabis product is selected from the group consisting of tablets, liquids, flower, capsules, or for vaporization.

3. The method of claim 1 wherein the color assigned to the THC to CBD ratio is selected from the group consisting of red, orange, yellow, green, blue, indigo, and violet.

4. The method of claim 3 wherein the THC to CBD ratio that is assigned to the color red is greater than about 18 to 1.

5. The method of claim 3 wherein the THC to CBD ratio that is assigned to the color orange is about 10-15 to 1.

6. The method of claim 3 wherein the THC to CBD ratio that is assigned to the color yellow is about 5-10 to 1

7. The method of claim 3 wherein the THC to CBD ratio that is assigned to the color green is about 1 to 1

8. The method of claim 3 wherein the THC to CBD ratio that is assigned to the color blue is about 1 to 5-10.

9. The method of claim 3 wherein the THC to CBD ratio that is assigned to the color indigo is about 1 to 10-15

10. The method of claim 3 wherein the THC to CBD ratio that is assigned to the color violet is less than 1 to 18.
